(19) United States
(12) Patent Application Publication
(10) Pub. No.: US 2009/0308865 A1
(43) Pub. Date: Dec. 17, 2009

(54) FUEL CONTAINER AND METHOD FOR MAINTENANCE OF A FUEL CONTAINER

(75) Inventors: Sonke Auer, Rosrath (DE); Klaus Gebert, Willich (DE); Timo Kraemer, Rott (DE); Ulrich Mayer, Bonn (DE)

Correspondence Address: GROSSMAN, TUCKER, PERREAULT & PFLEGER, PLLC, 55 SOUTH COMMERICAL STREET, MANCHESTER, NH, 03101, US

(73) Assignee: KAUTEX TEXTRON GMBH & CO. KG, Bonn (DE)

(21) Appl. No.: 12/482,678

(22) Filed: Jun. 11, 2009

(30) Foreign Application Priority Data
Jun. 11, 2008 (DE) 10 2008 027 830.0

(51) Int. Cl. B60K 15/03; B65D 6/00; B23P 6/00

(52) U.S. Cl. 220/4.13; 220/4.14; 220/694; 29/402.03

(57) ABSTRACT

The invention relates to a fuel container of plastics material with functional components arranged inside the container which are fastened to the container wall and at least some of which are connected to electric or hydraulic lines and/or are interconnected via such lines. The invention further relates to a method for maintenance of such a fuel container. The functional components are provided with fastening means for receiving a functionally identical functional component. In the event of maintenance, the fuel container is opened. An exchange component is fastened to the functional component to be serviced, the functional component to be serviced serving as a mounting for the exchange component. The lines connected to the functional component are plugged into the other functional component and the container is closed again while the component to be serviced remains in the fuel container.

The invention relates to a fuel container of plastics material with functional components arranged inside the container, which functional components are fastened to the container wall and at least some of which are connected to electrical or hydraulic lines and/or are connected to one another via such lines.

In the production of technical components such as fuel containers, which are produced from thermoplastic material in one piece or in multiple parts, it is necessary to fasten various built-in parts or add-on parts to the hollow body. Such built-in or add-on parts are, for example, operational or tank-filling vent valves and safety valves, and surge containers and the like. The fastening of the built-in parts may take place in the first heat during the production process, or subsequently. In the case of built-in components arranged in the interior of the container it is often necessary, depending on their size, for these to be introduced into the hollow body during production thereof. The built-in parts are locked to the container wall or welded thereto, in which case the welding may take place during production of the hollow body in the first heat or subsequently, for example by friction welding or welding using heat reflectors.

Current fuel containers have comparatively irregular upper contours and have vent points at widely different locations on the container wall. All the vent points of the fuel container are interconnected by vent lines, since venting usually takes place via an active carbon filter arranged inside or outside the fuel container. Fuel level sensors are also arranged at widely different locations of the fuel container and are connected by electric lines to an electrical interface of the motor vehicle. The lines are generally brought together in the region of a pump unit arranged centrally in the container. This pump unit is usually accessible through a service or maintenance opening in the fuel container, or is arranged in the container in a position closing such an opening.

In the event of maintenance, the interior of the fuel container can be made accessible via such a service opening.

However, depending on the fastening, arrangement and size of the functional components provided in the fuel container, it can be difficult to exchange a functional component to be serviced. For this reason the components of a fuel container, or the fuel container itself, are designed to last the service life of the motor vehicle.

It is the object of the invention to provide a fuel container of the type mentioned in the introduction, the maintainability or serviceability of which is improved. It is further an object of the invention to provide a method for maintenance of such a fuel container.

The object is achieved, firstly, by a fuel container of plastics material with functional components arranged inside the container which are fastened to the container wall and at least some of which are connected to electrical or hydraulic lines and/or are interconnected via such lines, the fuel container according to the invention being characterised in that at least some of the functional components are provided with fastening means for receiving an identical or functionally identical functional component as an exchange component.

In this way a corresponding functional component may be fastened to a functional component to be serviced, the functional component to be serviced serving as a fastening means for the functional component to be exchanged. This is advantageous, in particular, if the functional components to be serviced or exchanged are connected non-detachably to the container wall, for example by welding, riveting or the like. Separate fastening of the exchange component to the container wall can be dispensed with. Such a fuel container according to the invention can be serviced in an especially simple and low-cost manner.

Latching and/or joining connections on the functional components concerned are preferably provided as fastening means.

For example, grooved profiles may be provided as joining connections, for example in the form of dovetail profiles. Combinations of joining and latching connections or bayonet connections may also be provided, depending on the configuration of the component. The component to be exchanged is advantageously provided with fastening means complementary thereto. For example, the component to be serviced may be provided with a dovetail-profiled groove, whereas the exchange component is provided with a correspondingly contoured tongue. A large number of plug-in, snap-in and latching connections are possible.

In a variant of the fuel container according to the invention it is provided that the functional components are each connected via plug-in connections or rapid-action couplings to hydraulic or electric lines.

The above-mentioned object is further achieved by a method for the maintenance of a fuel container of plastics material with functional components arranged in a fixed manner therein, which functional components are connected to hydraulic or electric lines and/or are interconnected by such lines, the fuel container being opened in the event of maintenance and at least one exchange component being fastened to a functionally corresponding functional component arranged in the container, the functional component to be serviced being detached from the connected line, the exchange component being connected to the free line and the fuel container being closed again while the functional component which has been put out of operation remains in the fuel container.

It is therefore provided according to the invention that a second, functionally identical component is fastened to the component to be serviced as an exchange component, the component to be serviced serving as a fastening for the component to be exchanged. It is then necessary only to transfer the connections configured as plug-in connections or rapid-action couplings from the component to be serviced to the exchange component.

The functional components taken out of operation can remain in the fuel container. The fuel container is then closed once again in a liquid-tight and gastight manner.

The invention is explained below with reference to an exemplary embodiment represented in the drawings, in which:

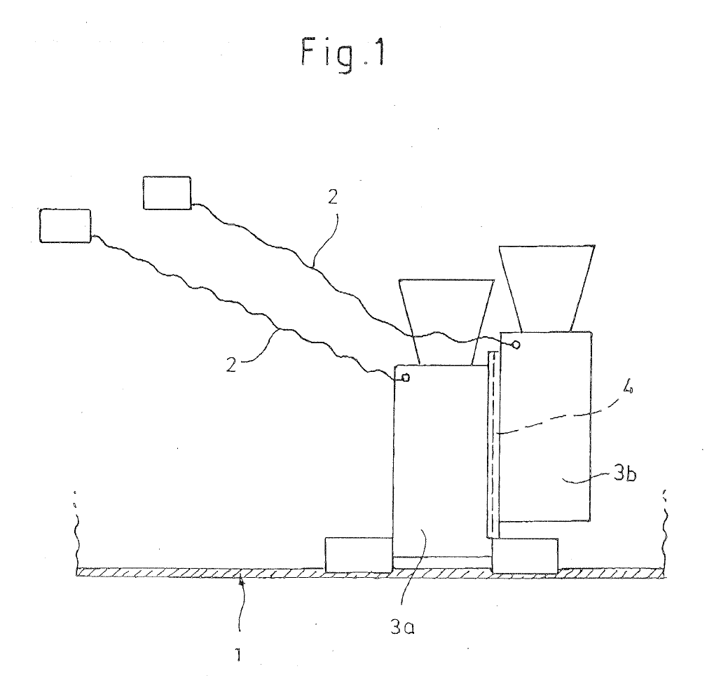

FIG. 1 is a schematic representation of a part of the fuel container with two fuel level sensors arranged on the base of the container, and

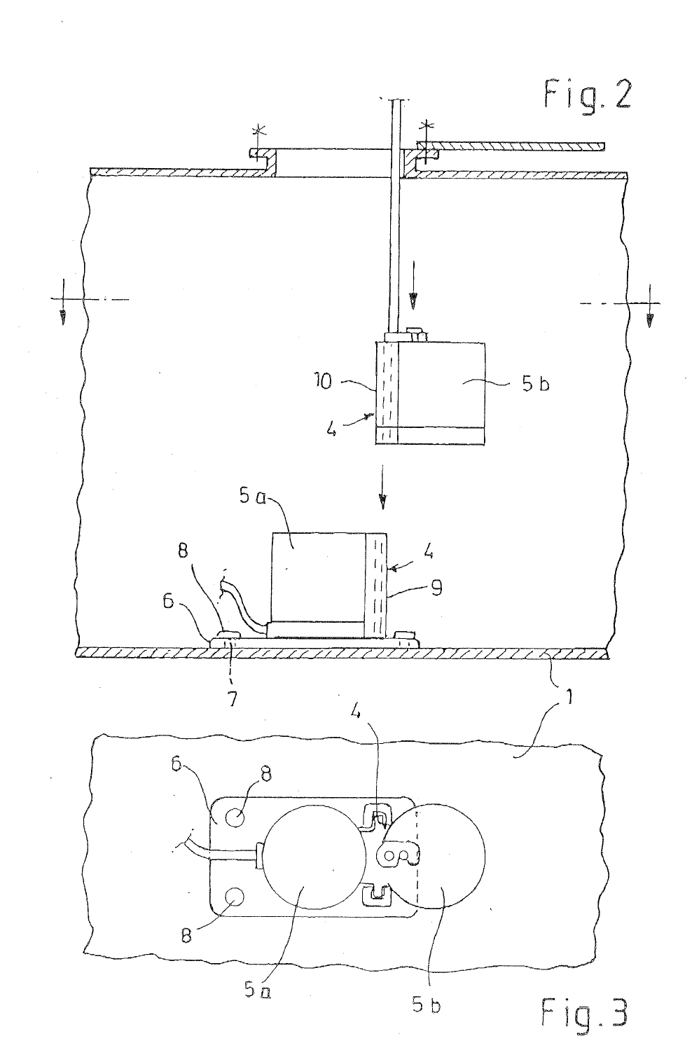

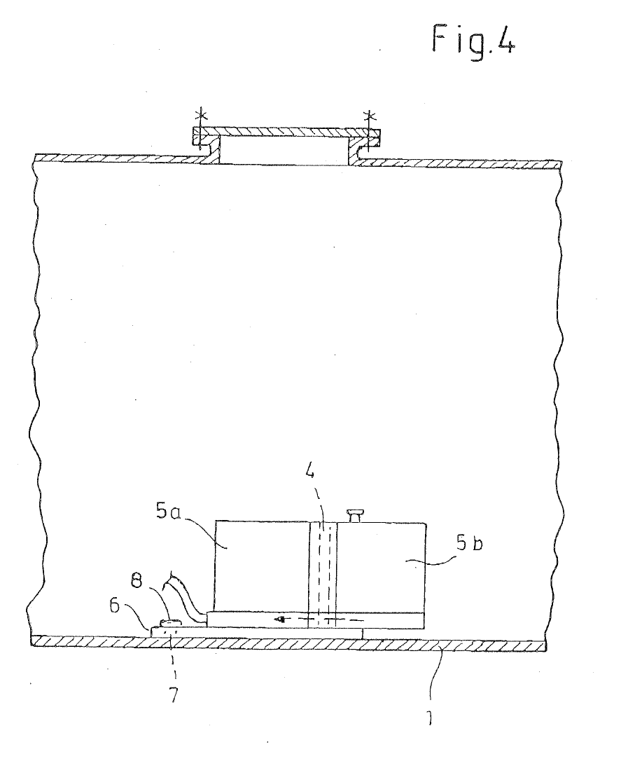

FIGS. 2 to 4 are schematic representations of a fuel container with a vent valve arranged on the container wall as a functional component and with an exchange component to be fastened thereto.

For the sake of simplicity the fuel container according to the invention is not illustrated completely; only the container wall 1 with functional components attached thereto is shown in the drawings.

Although the fuel container described has been referred to hereinbefore as a fuel container for a motor vehicle, the invention should be understood in principle in such a manner that it can be applied to a closed plastics container with built-in parts for other purposes.

The fuel container according to the invention is preferably in the form of an extrusion blow moulded plastics container into which built-in parts have been introduced during its production and in which the built-in parts are connected in a positive manner, preferably welded or riveted, to the container wall 1 and are therefore fixed non-detachably to the container wall. The fuel container may be in the form, as is usual, of a multi-layer coextrudate of thermoplastic material with barrier layers for hydrocarbons and may include one or more maintenance openings. However, the latter are not necessarily present; in the event of maintenance the container may also be opened by cutting suitable circular holes. These openings are then finally closed in a gastight and liquid-tight manner with a welded closure. A fuel container of the type described here usually has a filling opening in the form of a filling connection piece and at least one vent opening. However, the venting of the container may also be effected through vent lines located in the filling pipe.

The fuel container is further provided with at least one pump unit provided with a fuel level sensor and a plurality of vent valves, and optionally with a plurality of fuel level sensors arranged remote from the pump unit. These functional components are connected to electric or hydraulic lines 2.

FIG. 1 shows by way of example the exchange of a fuel level sensor 3 fastened in a form-fitting manner to the container wall 1. The fuel level sensor 3a to be serviced is connected non-detachably in a form-fitting manner to the container wall 1, in this case the container base. The fuel level sensor 3a (functional component) is connected via an electric line 2 to another functional component inside the fuel container. In the event of maintenance, the fuel level sensor 3b as the exchange component is now fastened to the fuel level sensor 3a by means of a detachable dovetail connection 4. The line 2 is detached from the fuel level sensor 3a and connected to the fuel level sensor 3b. The fuel container can then be closed again, the fuel level sensor 3a serving as a mounting for the fuel level sensor 3b and remaining in the fuel container.

Such a maintenance case is represented in FIGS. 2 to 4 with reference to a tank-filling vent valve 5 fastened to the tank wall. For reasons of clarity, the container wall 1 is shown at the bottom in FIG. 2, so that the tank-filling vent valve 5a is supported against the container wall 1, although in the installed position of the fuel container the tank-filling vent valve 5a is oriented downwardly, that is in the direction of gravity.

The tank-filling vent valve 5a is provided with a fastening pedestal 6, through the openings 7 of which pass rivet-type fastening pegs 8 formed from the container wall 1. The tank-filling vent valve 5a is connected non-detachably to the container wall 1. The tank-filling vent valve 5a is connected via a hydraulic line 2 to another vent point or to an active carbon filter inside the fuel container.

The tank-filling vent valve 5a is provided with a latching receptacle 9 which cooperates with a complementary latching element 10 of a tank-filling vent valve 5b as the exchange component.

In the event of maintenance, the tank-filling vent valve 5b latches in a form-fitting manner with the tank-filling vent valve 5a and the hydraulic line 2 is removed from the tank-filling vent valve 5a and connected to the tank-filling vent valve 5b as the exchange component.

Alternatively, the tank-filling vent valves 5a, 5b may communicate with one another hydraulically by means of suitable connections, which may be configured as plug-in connections, so that the repositioning of the line 2 can also be dispensable.

### LIST OF REFERENCES

1 Container wall
2 Lines
3a Fuel level sensor as component to be serviced
3b Fuel level sensor as exchange component
4 Dovetail guide
5a Tank-filling valve as functional component
5b Tank-filling valve as exchange component
6 Fastening pedestal
7 Openings
8 Fastening pegs
9 Latching receptacle
10 Latching element

1. Container made of plastics material with functional components arranged inside the container which are fastened to the container wall and at least some of which are connected to electric or hydraulic lines and/or are interconnected by such lines, characterised in that at least some of the functional components are provided with fastening means for receiving an identical or functionally identical functional component as an exchange component.

2. Container according to claim 1, characterised in that latching and/or joining connections are provided on the functional components concerned as fastening means.

3. Container according to claim 1, characterised in that the functional components are connected to hydraulic or electric lines via respective plug-in connections.

4. Container according to claim 1, characterised in that the container is in the form of a fuel container for motor vehicles.

5. Method for maintenance of a fuel container of plastics material with functional components arranged in a fixed manner therein which are connected to hydraulic or electric lines and/or are interconnected by such lines, the fuel container being opened in the event of maintenance and at least one exchange component being fastened to a functionally corresponding functional component arranged in the container, the functional component to be serviced being detached from the connected line, the exchange component being connected to the free line and the fuel container being closed again while the functional component which has been taken out of operation remains in the fuel container.
